(19) United States
(12) Patent Application Publication
(10) Pub. No.: US 2013/0294319 A1
(43) Pub. Date: Nov. 7, 2013

(54) Base Station, Radio Device, and Methods for Transmitting Data in a Radio Communications System

(71) Applicants: Mikko Markus Haapaniemi, Tampere (FI); Juergen Hofmann, Merching (DE)

(72) Inventors: Mikko Markus Haapaniemi, Tampere (FI); Juergen Hofmann, Merching (DE)

(21) Appl. No.: 13/879,194

(22) PCT Filed: Oct. 6, 2011
(86) PCT No.: PCT/EP2011/067521

§ 371 Date: Jul. 16, 2013

(30) Foreign Application Priority Data
Oct. 14, 2010 (EP) PCT/EP2010/065486

(51) Int. Cl. H04W 72/04

(52) U.S. Cl. CPC H04W 72/048
USPC 370/312; 370/329; 370/336

(57) ABSTRACT

The present invention refers to transmitting data in a radio communications system. In particular, a method and devices are presented for receiving and transmitting, on a channel, a sequence of radio blocks, the sequence further being divided into a first subset of the sequence of radio blocks which is allocated for user traffic of a first group of radio devices or of a second group of radio devices, and into a second subset of the sequence of radio blocks which is allocated for common control channel information relating only to the second group of radio devices, wherein the first and second subsets of radio blocks are transmitted on the same channel.

### FIELD OF THE INVENTION

The present invention relates to transmitting data in a radio communications system. Particularly, the present invention refers to methods for said transmitting; a radio base station configured to perform said transmitting; and a radio device configured to perform said transmitting.

### BACKGROUND OF THE INVENTION

In mobile networks, different types of devices are operated, characterized by different traffic behaviour, such devices as cellular phones, smart phones and devices used for machine type communication (MTC). The use cases for MTC devices are manifold: smart metering, e-health, fleet management, bridge monitoring, object and person tracking, theft detection, etc. Thus the traffic profile for such MTC devices will be different to that for usual cellular phones. The number of MTC devices is expected to grow fast in the coming years and will be a multiple of that of cellular phones.

The introduction of MTC devices will increase the load on common control channels as well as on traffic channels in radio access networks, e.g. GSM/EDGE networks. Depending on the specific MTC application in use, the terminated or originated traffic of the MTC device may be bursty and may thus yield traffic peaks if cumulated with that from cellular phones resulting in possible overload situations. In addition MTC devices may send information in synchronized manner to the network, e.g. in case of smart metering applications where devices send their measurement reports after the measurement is complete (e.g. after midnight). In this case several MTC devices will attempt to access the network. The current control channel structures in radio access networks are optimized for cellular phones and will not work efficiently in this scenario in that
increased access of MTC devices on the access channel (e.g. RACH) will delay/block access attempts of cellular phones and in particular if these are high priority calls or emergency calls;
increased signaling to MTC devices on the access grant channel (e.g. AGCH) or on paging channel (e.g. PCH) will delay/block reception of access grant messages or paging messages for cellular phones;
increased load on traffic channels due to MTC devices will yield delays or increased need for call redirection to other cells for a cellular phone in case of simultaneous incoming call from that cellular phone.

Thus mitigation of congestion and overload situations for the mixed traffic scenario generated by cellular phones and MTC devices is essential for optimum network performance.

Currently in the specifications no specific treatment of MTC devices is standardized. MTC devices are not distinguished from cellular phones within the radio protocol layer.

In order to increase capacity in common control channels, the usage of multiple Broadcast Control Channel (BCCH)/Broadcast Control Channel (CCCH) has been introduced and is used in real networks. Normally time slot (TS) 0 of the BCCH carrier is used to transmit the BCCH. Other timeslots on the BCCH carrier are employed for dedicated signaling or dedicated traffic channels. By the feature of multiple BCCH/CCCH, additional resource is available for broadcast control and common control channels on the BCCH carrier, e.g. timeslots 2, 4 and 6, which allows for higher access rates and hence for mitigating overload situations on the access control channels. The drawbacks of this solution are:
no discrimination between MTC and cellular phones is possible and hence both access the same resource yielding increased delay/blocking for cellular phones;
capacity of additional resource for multiple BCCH/CCCH cannot be used for traffic channels, unless major system information messages are updated to reconfigure the broadcast and common control channel configuration.

The introduction of a radio access protocol discriminating between MTC devices and cellular phones is being investigated in 3GPP. A solution based on the extension of the definition of access classes is under discussion in 3GPP, which allows to mitigate the overload situation for cellular phones but does not optimize the access for MTC devices in terms of delay and access success rate due to partial or overall access barring of MTC devices for a given time period based on the barred access classes signaled by the network.

Thus, there is still a need for an improved procedure for a radio base station, and in particular for improved radio access control methods with regard to the different traffic behavior of radio devices.

### SUMMARY OF THE INVENTION

Object of the present invention is improving of data transmission in a radio communications system.

This object is achieved by methods comprising features according to claims 1 and 13, a radio base station comprising features according to claim 7, and a radio device comprising features according to claim 20.

Further embodiments of the present invention are provided with the corresponding dependent claims.

The object of the present invention is achieved by a method for a radio base station, the method comprising receiving and transmitting, on a channel, a sequence of radio blocks, the sequence further being divided into a first subset of the sequence of radio blocks which is allocated for user traffic of a first group of radio devices or of a second group of radio devices, and into a second subset of the sequence of radio blocks which is allocated for common control channel information relating only to the second group of radio devices, wherein the first and second subsets of radio blocks are transmitted on the same channel.

According to embodiments of the present invention, a radio block of the second subset of the sequence of radio blocks comprises an uplink state flag related to a radio device of a first group of radio devices or to a second group of radio devices, and wherein the radio block further comprises common control channel information relating to a radio device of the second group of radio devices.

According to embodiments of the present invention, the method further comprises signalling, on the channel, a resource allocation map, the resource allocation map specifying the sequence of radio blocks allocated for transmissions over the channel.

According to embodiments of the present invention, the resource allocation map further comprises an update period indicator, the update period indicator defining a time interval during which the resource allocation map is valid.

According to embodiments of the present invention, the common control channel information comprises broadcast information or access grant information or paging information related only to the second group of radio devices.

According to embodiments of the present invention, the method further comprises signalling, on a broadcast channel, an indication on the presence of the channel and resource allocation information on the channel.

The object of the present invention is also achieved by a radio base station comprising receiving and transmitting means configured for receiving and transmitting, on a channel, a sequence of radio blocks, the sequence further being divided into a first subset of the sequence of radio blocks which is allocated for user traffic of a first group of radio devices or of a second group of radio devices, and into a second subset of the sequence of radio blocks which is allocated for common control channel information relating only to the second group of radio devices, wherein the first and second subsets of radio blocks are transmitted on the same channel.

According to embodiments of the present invention, a radio block of the second subset of the sequence of radio blocks comprises an uplink state flag related to a radio device of a first group of radio devices or to a second group of radio devices, and wherein the radio block further comprises common control channel information relating to a radio device of the second group of radio devices.

According to embodiments of the present invention, the radio base station comprises resource allocation map signalling means configured for signalling, on the channel, a resource allocation map, the resource allocation map specifying the sequence of radio blocks allocated for transmissions over the channel.

According to embodiments of the present invention, the radio base station further comprising signalling means configured for signalling, on a broadcast channel, an indication on the presence of the channel and resource allocation information on the channel.

The object of the present invention is also achieved by a method for a radio device, the method comprising receiving and transmitting, on a channel, a sequence of radio blocks the sequence further being divided into a first subset of the sequence of radio blocks which is allocated for user traffic of a first group of radio devices or of a second group of radio devices, and into a second subset of the sequence of radio blocks which is allocated for common control channel information relating only to the second group of radio devices, wherein the first and second subsets of radio blocks are transmitted on the same channel.

According to embodiments of the present invention, the method further comprises receiving, on the channel, a resource allocation map, the resource allocation map specifying the sequence of radio blocks allocated for transmissions over the channel.

According to embodiments of the present invention, the method further comprises receiving, on a broadcast channel, an indication on the presence of the channel and resource allocation information on the channel.

According to embodiments of the present invention, the method further comprises listening to common control channel information only within a radio block of the subset of the sequence of radio blocks; and/or transmitting common control channel information only within a radio block of the subset of the sequence of radio blocks.

The object of the present invention is also achieved by a radio device comprising receiving and transmitting means configured for receiving and transmitting, on a channel, a sequence of radio blocks, the sequence further being divided into a first subset of the sequence of radio blocks which is allocated for user traffic of a first group of radio devices or of a second group of radio devices, and into a second subset of the sequence of radio blocks which is allocated for common control channel information relating only to the second group of radio devices, wherein the first and second subsets of radio blocks are transmitted on the same channel.

According to embodiments of the present invention, a radio block of the second subset of the sequence of radio blocks comprises an uplink state flag related to a radio device of a first group of radio devices or to a second group of radio devices, and wherein the radio block further comprises common control channel information relating to a radio device of the second group of radio devices.

According to embodiments of the present invention, the radio device further comprising receiving means configured for receiving, on the channel, a resource allocation map, the resource allocation map specifying the sequence of radio blocks allocated for transmissions over the channel.

According to embodiments of the present invention, the radio device further comprising receiving means configured for receiving, on a broadcast channel, an indication on the presence of the channel and resource allocation information on the channel.

According to embodiments of the present invention, the radio device further comprising:
listening means configured for listening to common control channel information only within a radio block of the second subset of the sequence of radio blocks; and
transmitting means configured for transmitting common control channel information only within a radio block of the subset of the sequence of radio blocks.

### BRIEF DESCRIPTION OF THE DRAWINGS

The present invention will be more clearly understood from the following description of the preferred embodiments of the invention read in conjunction with the attached drawings, in which:

FIG. 1 shows an implementation of the present invention according to some embodiments of the present invention;

FIG. 2 shows an implementation of the present invention according to some embodiments of the present invention;

FIG. 3 shows an implementation of the present invention according to some embodiments of the present invention;

FIG. 4 shows an implementation of the present invention according to some embodiments of the present invention;

FIG. 5 shows an implementation of the present invention according to some embodiments of the present invention; and

FIG. 6 shows an implementation of the present invention according to some embodiments of the present invention.

### DESCRIPTION OF THE PREFERRED EMBODIMENTS

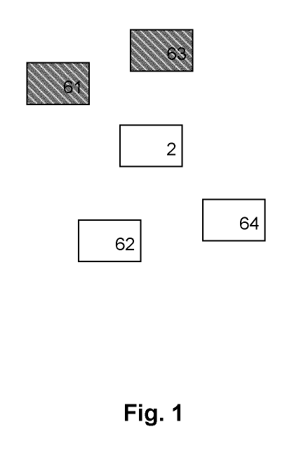

FIG. 1 shows an implementation of the present invention according to some embodiments of the present invention.

In particular, FIG. 1 shows parts of a radio communications network, in which the invention can be applied. A radio base station 2 is serving radio devices 61, 62, 63, 64. The radio devices are grouped into two separate groups with a first group of radio devices 62, 64 and a second group of radio devices 61, 63.

According to some embodiments of the invention, the first group of radio devices 62, 64 comprises, e.g., cellular phones with a regular traffic behaviour, and the second group of radio devices 61, 63 comprises, e.g., smart phones or devices used for machine type communication. As stated above, the traffic profile for such MTC devices will be different to that for usual cellular phones.

It has to be noted that the first group of radio devices and second group of radio devices may overlap, i.e. an MTC device might also be a cellular phone, therefore belonging also to the first, “normal” group of devices.

It may also be the same group of radio devices, say the channel is only foreseen for MTC devices. The different groups are rather characterized by different channel status. One group is in idle or access mode, the other in connected mode. In addition it may be different devices.

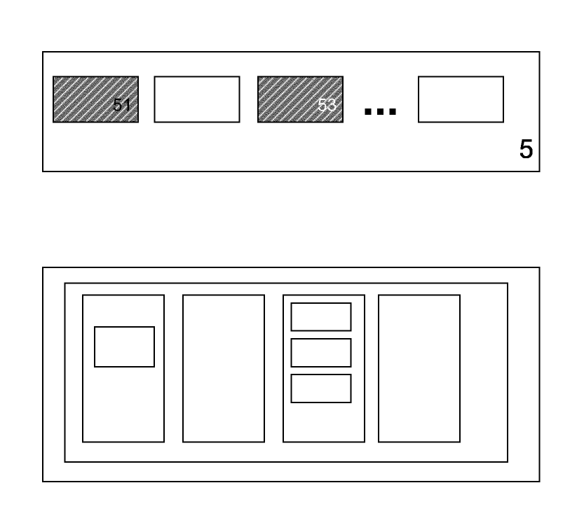

FIG. 2 shows an implementation of the present invention according to some embodiments of the present invention.

In the standard specifications, there exists already two operation modes for USF multiplexing for (E)GPRS services, they cannot be mixed at a time (would need channel reconfiguration):
1) USF granularity=1:
All radio blocks on DL 51 . . . 54 contain the USF flag for granting the transmission during the next radio block (only one UL radio block is granted). This is the preferred mode if all transmissions in DL are based on one modulation type, i.e. GMSK OR 8-PSK.
2) USF granularity=4:
The uplink is granted for a sequence of 4 radio blocks. This is the preferred mode for a mix of GMSK and 8-PSK modulation types on DL. Then the first radio block out of a sequence of 4 radio blocks is modulated in GMSK, so that mobiles accessing the UL know which USF is permitted. Then this mobile with indicated USF is allowed to access on 4 subsequent radio blocks. In the remaining 3 radio blocks on downlink the BTS may use 8-PSK modulation for packet traffic channel, if the mobile supports it, to serve higher data rates on DL. Only the next radio frame must then be encoded in GMSK to allow for reading of GPRS mobiles. The USF sent in a downlink radio block may allow access on UL for one or a series of UL radio blocks.

In particular, FIG. 2 shows a channel 5 comprising a sequence of radio blocks 51, 52, 53, 54 for transmissions over the channel 5. According to the invention, a first subset 52, 54 of said sequence of radio blocks 51, 52, 53, 54 is to be used, or allocated, for transmitting user traffic 512 of the first group of radio devices 62, 64, i.e. for user traffic of cellular phones with a regular traffic behaviour. A second subset 51, 53 of said sequence of radio blocks 51, 52, 53, 54 is to be used, or allocated, for transmitting common control channel information 513 relating to the second group of radio devices 61, 63, i.e. for CCCH information relating to smart phones or devices used for machine type communication with a different traffic profile compared to that for usual cellular phones.

Transmissions in the scope of this invention should be understood as downlink and/or uplink transmissions, as the radio blocks are allocated for both, downlink and uplink transmissions, i.e. transmissions from the base station to radio devices and vice versa or separately for UL and DL in case of asymmetric allocation.

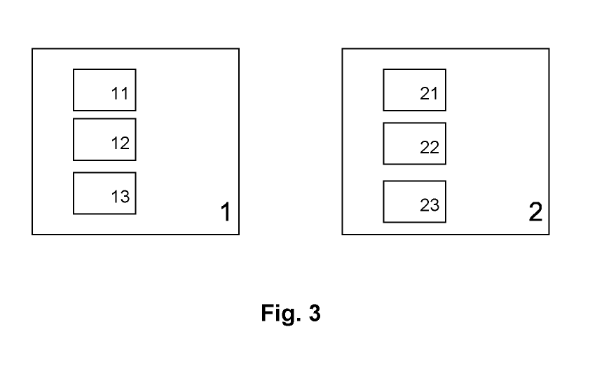

According to the invention, the allocation of the radio blocks in the sequence of radio blocks 51, 52, 53, 54 is announced to radio devices 61, 62, 63, 64 by means of a resource allocation map 511, which will be explained in more detail in conjunction with FIG. 3.

FIG. 3 shows an implementation of the present invention according to some embodiments of the present invention. In particular, FIG. 3 shows, in more detail, the base station 2 already shown in FIG. 1, and a method 1 performed by the base station 2 for transmitting data in the radio communications system.

The method 1 comprises receiving and transmitting 11, on a channel 5, a sequence of radio blocks 51, 52, 53, 54, the sequence further being divided into a first subset 52, 54 of the sequence of radio blocks 51, 52, 53, 54 which is allocated for user traffic 512 of a first group of radio devices 62, 64 or of a second group of radio devices 61, 63, and into a second subset 51, 53 of the sequence of radio blocks 51, 52, 53, 54 which is allocated for common control channel information 513 relating only to the second group of radio devices 61, 63, wherein the first 52, 54 and second 51, 53 subsets of radio blocks are transmitted on the same channel 5.

According to some embodiments of the invention, the resource allocation map 511 further comprises an update period indicator 5111, as shown in FIG. 2. The update period indicator 5111 defines a time interval during which the resource allocation map 511 is valid.

According to further embodiments of the invention, the time interval is signaled as a number of radio blocks for which the resource allocation map 511 is valid.

According to further embodiments of the invention, a radio block 51 of the second subset 52, 54 of the sequence of radio blocks 51, 52, 53, 54 comprises an uplink state flag 514 related to a radio device of a first group of radio devices 62, 64 or to a second group of radio devices 61, 63, and wherein the radio block 51 further comprises common control channel information 513 relating to a radio device of the second group of radio devices 61, 63.

The radio base station 2 as shown in FIG. 3 comprises receiving and transmitting means 21 configured for receiving and transmitting the sequence of radio blocks 51, 52, 53, 54 on the channel 5.

The resource allocation map 511 is specifying the sequence of radio blocks 51, 52, 53, 54 allocated for transmissions over the channel 5.

According to some embodiments of the invention, the method 1 further comprises signalling 12, on a broadcast channel 7, an indication 71 on the presence of the channel 5 and resource allocation information 72 on the channel 5.

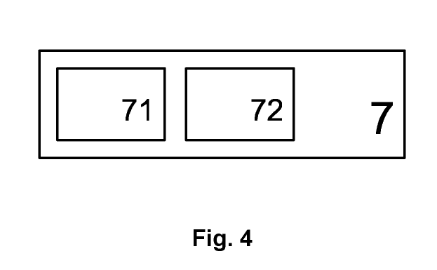

Further embodiments of the invention will now be discussed in conjunction with FIG. 4.

FIG. 4 shows an implementation of the present invention according to some embodiments of the present invention. In particular, FIG. 4 shows a broadcast channel 7 and an indication 71 on the presence of the channel 5. This indication 71 is signaled on the broadcast channel 7.

According to further embodiments of the invention, the method 1 further comprises signalling 12, on the broadcast channel 7, the indication 71 on the presence of the channel 5.

According to further embodiments of the invention, the radio base station 2 as shown in FIG. 3 further comprises signalling means 22 configured for signalling, on the broadcast channel 7, the indication 71 on the presence of the channel 5.

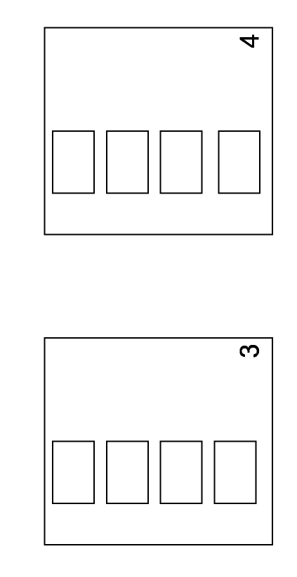

FIG. 5 shows an implementation of the present invention according to some embodiments of the present invention. In particular, FIG. 5 shows a radio device 4 according to the invention, and a method 3 for the radio device 4.

The radio device 4, e.g. a smart phone or a device used for machine type communication, receiving and transmitting means 41 configured for receiving and transmitting, on a channel 5, a sequence of radio blocks 51, 52, 53, 54, the sequence further being divided into a first subset 52, 54 of the sequence of radio blocks 51, 52, 53, 54 which is allocated for user traffic 512 of a first group of radio devices 62, 64 or of a second group of radio devices 61, 63, and into a second subset 51, 53 of the sequence of radio blocks 51, 52, 53, 54 which is allocated for common control channel information 513 relating only to the second group of radio devices 61, 63, wherein the first 52, 54 and second 51, 53 subsets of radio blocks are transmitted on the same channel 5.

According to some embodiments of the invention, the radio device 4 further comprises listening means 42 configured for listening to common control channel information 513 only within a radio block of the subset of the sequence of radio blocks 52, 54; and transmitting means 43 configured for transmitting common control channel information 513 only within a radio block of the subset of the sequence of radio blocks 52, 54.

According to the invention, the radio device 4 performs a method 3, the method 3 comprising receiving and transmitting 31, on a channel 5, a sequence of radio blocks 51, 52, 53, 54 the sequence further being divided into a first subset 52, 54 of the sequence of radio blocks 51, 52, 53, 54 which is allocated for user traffic 512 of a first group of radio devices 62, 64 or of a second group of radio devices 61, 63, and into a second subset 51, 53 of the sequence of radio blocks 51, 52, 53, 54 which is allocated for common control channel information 513 relating only to the second group of radio devices 61, 63, wherein the first 52, 54 and second 51, 53 subsets of radio blocks are transmitted on the same channel 5.

According to further embodiments of the invention, the method 3 further comprises listening 32 to common control channel information 513 only within a radio block of the subset of the sequence of radio blocks 52, 54; and/or transmitting 33 common control channel information 513 only within a radio block of the subset of the sequence of radio blocks 52, 54.

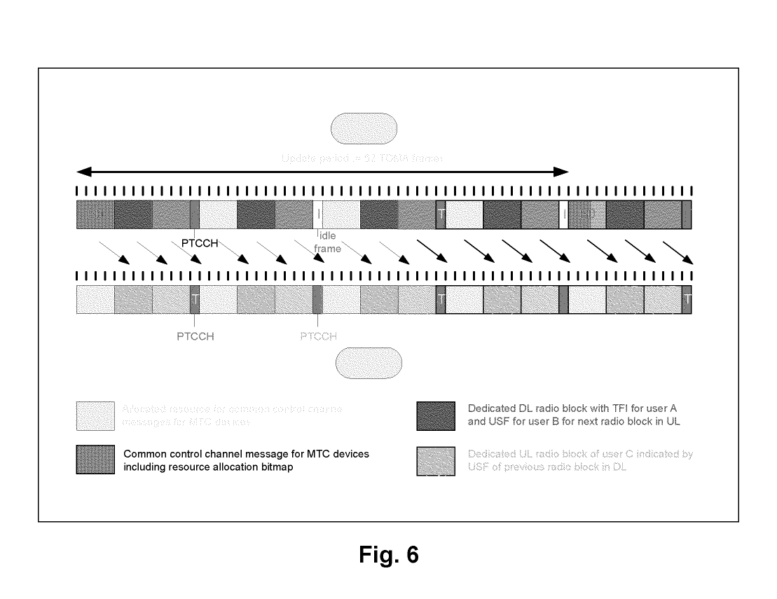

FIG. 6 shows an implementation of the present invention according to some embodiments of the present invention. In particular, FIG. 6 shows a more detailed representation of the invention. The invention will now be discussed in more detail in conjunction with FIG. 6.

The envisaged use cases for MTC devices are manifold: smart metering, e-health, fleet management, bridge monitoring, object and person tracking, theft detection etc. [1]. The traffic profile for such MTC devices will be different to that for usual mobile terminals in that transfer of small or medium size data will most often occur. Number of MTC devices is expected to grow fast in the coming years and will be a multiple of that of mobile terminals. Introduction of MTC devices will hence increase the load on common control channels as well as on traffic channels in GERAN networks yielding potential network overload situations. Hence the mitigation of such overload situations identifies a major objective in order to guarantee a high QoS in GERAN networks.

Different mitigation mechanisms are being investigated within the study item GERAN Network Improvements for MTC [2]. This contribution depicts a new concept—named hybrid MTC channel.

MTC devices are expected to add considerable traffic load to GERAN networks along their growing penetration in several ways.

Depending on the specific MTC application in use, the terminated or originated traffic of the MTC devices may be bursty and may thus yield traffic peaks if cumulated with that from mobile terminals resulting in possible network overload situations. Due to nature of the MTC traffic it is likely that the proportional amount of control traffic increases substantially faster than the amount of data traffic, as the initial MTC applications probably do not require large data transmissions (see [3] and [4]). Therefore MTC devices may leave traffic channels unused while CCCH channels such as RACH and AGCH become very congested. This could potentially even block emergency call attempts, for example in a case where a timer triggers simultaneous reporting from a large amount of utility meters (e.g. after midnight) and hence several MTC devices will attempt to access the network at the same time.

The current control channel structure in GERAN networks is optimised for mobile terminals and will not work efficiently in this scenario in that

increased access of MTC devices on RACH will delay/block access attempts of mobile terminals and in particular if these are high priority calls or emergency calls;

increased signalling to MTC devices on AGCH or on PCH will delay/block reception of access grants or paging messages for mobile terminals;

increased load on traffic channels due to MTC devices will yield delays or increased need for call redirection to other cells for a mobile terminals in case of simultaneous high MTC traffic load;

Thus mitigation of congestion and overload situations for the mixed traffic scenario generated by mobile terminals and MTC devices is essential for optimum network performance.

The concept of a hybrid MTC channel to alleviate the risk of network overload situations for increased penetration of MTC devices is depicted hereafter.

It occupies a specific timeslot of the BCCH carrier. Timeslot 7 is chosen due to the fact that timeslots 2, 4 and 6 may be in use because of multiple BCCH/CCCH, and timeslots 1 and 2 may be occupied by RACH if the cell radius exceeds 35 km. The purpose of the hybrid MTC channel is to serve both MTC devices in idle mode and during channel access phase as well as mobile terminals or MTC devices with a dedicated packet data connection at the same time. This is done dynamically, to ensure that varying load from MTC devices over the day can be taken into account.

In order to achieve this segregation, the resource on hybrid MTC channel is split into resource for common control channels used by MTC devices and resource used by PDTCH for packet data users. The split is defined by a resource allocation bitmap broadcast by the BTS indicating when the hybrid MTC channel is reserved for PDTCH traffic and when it is reserved for common control channels for MTC devices only. The resource allocation bitmap is periodically updated and valid for a predefined time interval, which is signalled together with the resource allocation bitmap.

The presence of the hybrid MTC channel and its allocation is indicated in specific system information messages on the BCCH carrier. After evaluating the presence of the hybrid MTC channel, the MTC devices will camp on the hybrid MTC channel in order to perform any channel access. After camping on the hybrid MTC channel the MTC devices attempt to read the resource allocation bitmap. In case the bitmap has been received and evaluated, the MTC device has knowledge when it is allowed to send channel requests and when it should listen to downlink common control channels.

The signaled UL resource for the common control channels for MTC devices is reserved for RACH to be used by MTC devices only.

The signalled DL resource for the common control channels for MTC devices is reserved for information broadcasts to all MTC devices in the cell as well as for AGCH and PCH for all MTC devices in the cell. The inclusion of common control channels for MTC devices in the hybrid MTC channel enables also the sending of system information messages that are similar to the ones currently in use on BCCH, but optimized for MTC purposes. Nevertheless hybrid MTC channel is designed to support channel access for MTC devices and hence such messages are not frequently sent. Rather MTC devices are required to read BCCH messages with a minimum frequency. Hence in case of introduction of hybrid MTC channel new BCCH monitoring rules for MTC devices may be required.

With regard to location and routing area update signalling procedures for MTC devices, these are not affected in case of MTC devices in connected mode, due to the fact that signalling is done over the dedicated channel using either SDCCH, TCH or PDTCH, respectively. However for MTC devices in (packet) idle mode transmission of resource request and receive assignment messages for location updating request or routing area update request should make use of the common control channels of the hybrid MTC channel.

The remaining resource in UL and DL on the hybrid MTC channel is reserved for packet data connections using BTTI configurations. Legacy GPRS/EGPRS/EGPRS-2 mobiles are both served, based on transmission of their TFI and USF identities. All MTC common control channels in the hybrid MTC channel use a specific unique TFI in DL identity, which is pre-known by MTC devices to exclude misinterpretation by non-MTC devices. The messages are based on the legacy format of RLC/MAC control messages to ensure backwards compatibility for mobile terminals with packet data connection reading USF for uplink transmission.

This concept of hybrid MTC channel is depicted in FIG. 1, upper part.

The allocation of MTC common control channels in the hybrid MTC channel is configured dynamically. The BSS adjusts this allocation depending on the actual traffic load from MTC devices and/or GPRS/EGPRS/EGPRS2 packet data users. For example, several radio blocks for MTC common control channels are configured if it is known that a large amount of utility meters are going to make a regular report during a certain interval. After the peak in MTC traffic has passed, the resource allocation bitmap is updated and only few radio blocks are assigned to MTC common control channels to make room for packet data users.

To this purpose the resource allocation bitmap is sent at predefined times, e.g. within the block B0 indicating the resource allocation of common control channels for MTC devices and the resource allocation of PDTCHs, which the MTC devices are not allowed to use in uplink for common control purposes. Two operational modes of the hybrid MTC channel are foreseen: In the symmetric operational mode, the resources for DL and UL common control channels for MTC devices are covering the same TDMA frames. Thus the resource allocation bitmap does only include one link direction for the next update period. In the asymmetric operational mode, the resources for DL and UL common control channels for MTC devices are different and hence the resource allocation bitmap includes both link directions for the next update period.

The indication of the operational mode of the hybrid MTC channel could be either done on BCCH in static or semi-dynamic manner or alternatively within the hybrid MTC channel signalled together with the resource allocation bitmap allowing a full dynamic manner. On DL the MTC common control channel needs to carry the USF of the user that is assigned the next radio block in UL.

The resource allocation bitmap describes the channel allocation for a predefined time, i.e. the update period. After completion of the update period a new bitmap is sent which may be different in content and in length:

The content of the bitmap may change due to adaptation to actual traffic profile from MTC devices and mobile terminals by varying number and location of MTC common control channels. On the other hand a low activity of MTC devices does not require a frequent update of the resource allocation bitmap. Hence the update period corresponding to the number of radio blocks contained in the resource allocation bitmap may be increased in this case.

Different update periods for the resource allocation bitmap are foreseen.

Let's first consider the symmetric operational mode of the hybrid MTC channel. If all radio blocks are explicitly specified in the bitmap one obvious limit is given by the size of the radio block. Assuming that all MTC common control messages are encoded in CS-1, the basic format of a downlink control RLC/MAC block is reused for all MTC common control channels in downlink. The advantage is that this does not require any coding changes. About 19-20 octets are available for coding of the resource allocation map corresponding to a maximum of about 150 bits and hence up to about 3 sec with each bit covering a 20 ms radio block.

Thus the update period in case of explicit signaling of all radio blocks in the resource allocation bitmap may range between 240 ms (interval between two B0 blocks) and 2880 ms, if the prerequisite is that the resource allocation bitmap is sent within block BO. Higher update periods than 2880 ms would require segmentation of the bitmap, which should be avoided to minimize signaling overhead. Hence suitable values for the update period for explicit block indication would be 240 ms, 480 ms, 720 ms, 1440 ms, 2880 ms.

In case of higher update periods implicit radio block indication is required. This is done by sending the bitmap explicitly for the first period of 2880 ms and then repeating the same bitmap once, twice or triple, depending on signaled value of 5760 ms, 11520 ms and 23020 ms. In total 8 code points are needed which can be coded into 3 bits.

FIG. 6, lower part shows encoding of the resource allocation bitmap for an update period of 240 ms and symmetric operational mode of the hybrid MTC channel covering 12 radio blocks as used in FIG. 6, upper part.

In case of asymmetric operational mode of the hybrid MTC channel, explicit signaling can only be done up to an update period of 1440 ms. Hence implicit radio block indication would already need to be used for higher update periods such as 2880 ms, 5760 ms, 11520 ms and 23020 ms.

Transmission of the resource allocation bitmap always occurs in B0 radio blocks and the MTC device needs to synchronize to the transmission of the resource allocation bitmap when listening to the hybrid MTC channel. This may require reception and detection of all B0 radio blocks for a duration equivalent to the maximum update period, as mentioned above, until the first instance of the resource allocation bitmap is detected. From this point in time onwards the MTC device can suspend reading of messages in every B0 radio block and only listen to the next known occurrence of the resource allocation bitmap which may yield power consumption savings.

It is important that misinterpretation of new messages, sent over common control channels of the hybrid MTC channel, by mobile terminals, that are assigned a PDTCH and that expect legacy RLC/MAC messages, is excluded. Therefore all messages sent on DL need to be equivalent to the structure of dedicated RLC/MAC control messages carrying the CS-1 format supported by legacy GPRS mobiles for USF detecting. All messages sent in MTC common control channels are hence dedicated to a virtual MS by employing a unique predefined Temporary Frame Identity (TFI) for those channels. For instance TFI=0 may be specified for this purpose. Also for USF a unique predefined identity is needed (e.g. USF=0 sent in radio blocks B2, B5, B8 and B11 in FIG. 6) to avoid false transmissions on MTC common control channels in UL by packet data users. This has following advantage: in case the MTC device has not yet received the resource allocation bitmap and needs to send a channel request, it can access the UL channel immediately once it has detected the predefined USF on DL. Thus channel access is possible also in this case. The MTC device thereafter listens to MTC downlink control channels by evaluating whether the signaled TFI corresponds to the predefined TFI and checking on the access acknowledgement.

The indication of the presence of the hybrid MTC channel is done in specific system information messages on BCCH, which are frequently scheduled. Only a single presence bit and the description of the timeslot number are needed, since the hybrid MTC channel has a dynamic nature in itself and can serve different traffic profiles. Hence this is advantageous in that no update of system information messages on BCCH is needed to switch on the MTC specific common control channels or increase their resource allocation and hence no time will be spent by mobile terminals for updating system information messages, which will not be impacting them.

Only in case the capacity of one timeslot for the hybrid MTC channel is not sufficient, updates to the BCCH are necessary to indicate the additional resource. In this case the presence element in the BCCH should be extended to indicate the number of timeslots on BCCH carrier carrying the hybrid MTC channel format.

The hybrid MTC channel carries also one or more paging sub channels dedicated to different MTC device types. Hence the regular CCCH is offloaded from signaling load due to MTC device paging.

It should be noted that all common control messages on hybrid MTC channel need to adapt to GPRS PDCH channel structure and hence will be specified in TS 44.060.

### MTC Device Implementation Aspects

When being in idle mode, the MTC device is required to check system information messages on BCCH for indication of presence and allocation of hybrid MTC channel. If the hybrid MTC channel is activated, it is required to synchronize to the resource allocation bitmap and to read common control channel messages on the hybrid MTC channel including information broadcast, paging requests, location updating requests and routing area update requests as well as access acknowledgements. For UL data transfer it needs to respect the resource allocation bitmap to detect when it is allowed to send channel requests to the network. RACH, AGCH and PCH on hybrid MTC channel function as specified in 3GPP specifications 44.018 and 44.060. This includes also the listening to paging sub channels on hybrid MTC channel dedicated to MTC devices.

Legacy GPRS/EGPRS/EGPRS-2 mobile terminals are not affected by the introduction of the hybrid MTC channel and will be supported on hybrid MTC channel in case of packet data traffic.

The BSS needs to indicate the presence and allocation of the hybrid MTC channel in the system information messages that are broadcast on BCCH.

On the hybrid MTC channel system information messages optimized for MTC devices, access acknowledgements, paging requests, location updating requests and routing area update requests need to be supported for MTC mobiles including the organization of paging sub channels dedicated to MTC devices. Furthermore the BSS needs to control the scheduling of the resource allocation bitmap in alignment to the actual traffic load from MTC devices and mobile terminals.

With the introduction of the hybrid MTC channel concept protection is gained against potential network overload caused by MTC devices on regular CCCH. In contrast to other investigated overload prevention mechanisms as discussed in [5] this concept does not lead to restricting or barring of channel access of MTC devices, but allows for it based on the defined resource segregation between common control channels for mobile terminals and those for MTC devices.

The hybrid MTC channel incorporates all flexibility to dynamically adjust to the actual traffic profile. The operator merely needs to configure the resource allocation bitmap with a certain update period in accordance with the capacity needs for dedicated packet data traffic. Care has to be taken related to the optimisation of suitable update periods to avoid too high latency in the channel access for MTC devices and on the other hand too high signalling overhead.

This concept provides increased efficiency when multiplexing mobile terminals and new MTC devices, in that no entire time slot capacity is lost for packet data traffic in case of low traffic load from MTC devices considering the expected dramatic increased penetration of the MTC devices within the coming years requiring such efficiency increase.

Furthermore the concept provides this flexibility without the need to update system information messages for indication of presence/absence of the MTC hybrid channel on BCCH which would affect operation of the entire population of mobile devices in the cell as being required in case of temporary activation of multiple BCCH/CCCH control channels on BCCH carrier.

Legacy GPRS/EGPRS/EGPRS-2 mobiles are not affected and will be supported on hybrid MTC channel in case of packet data traffic.

In the following, further aspects of the invention are described.

According to the invention, a new BCCH/CCCH (i.e. MTC control Channel) is introduced, which is used by MTC devices only.

The MTC control Channel occupies one timeslot of the BCCH carrier, it is proposed to be timeslot 7 (technically this control Channel could occupy any timeslot from timeslot 1 to timeslot 7 of BCCH carrier but timeslot 7 is the most optimized solution as timeslots 2, 4 and 6 may be in use because of multiple BCCH/CCCH and timeslots 1 and 2 may be occupied by RACH if cell radius exceeds 35 km). Message or messages, from principle similar to existing system information messages, is/are broadcasted on BCCH in this timeslot. Information broadcasted on this logical Channel is to be used by MTC devices only. Therefore message(s) broadcasted on this Channel can be optimised for MTC purposes. All uplink capacity of MTC control Channel is reserved for RACH to be used by MTC devices only. DL direction of MTC control Channel is reserved for information broadcasted to all MTC devices in cell, AGCH for MTC devices and PCH/PPCH for MTC devices.

Location and routing area update signalling procedures are not affected because of MTC control Channel because that signalling is done using SDCCH and PDTCH Channels respectively. Resource request and assignment messages for location updating request and routing area update request message will be sent using MTC control Channel. In addition to other standardised requirements for (E)GPRS devices when initiating UL data transfer MTC device is required to check from system information messages broadcasted on BCCH the presence of MTC control Channel. If this Channel is present MTC device has to read messages broadcasted on it to find out when it is allowed to send Channel request to network. MS could be also informed in messages broadcasted on MTC control Channel if MTC device should send Channel request on legacy RACH or on new RACH to be used by MTC devices only. Functionality of RACH and AGCH to be used by MTC devices only is as specified for RACH and AGCH in 3GPP specification 44.108 and 44.060.

Introduction of MTC control Channel provides overload protection mechanism to legacy CCCH against new load generated by MTC devices.

MTC control Channel means that MTC devices accessing GSM network do not necessarily load legacy CCCH at all. Network may command MTC devices witch are trying to send most delay critical data to use legacy RACH.

While embodiments and applications of this invention have been shown and described above, it should be apparent to those skilled in the art, that many more modifications (than mentioned above) are possible without departing from the inventive concept described herein. The invention, therefore, is not restricted except in the spirit of the appending claims. Therefore, it is intended that the foregoing detailed description should be regarded as illustrative rather than limiting.

### LIST OF ABBREVIATIONS

AGCH Access Grant CHannel

BCCH Broadcast Control CHannel

BSS Base Station Subsystem

CCCH Common Control CHannel

CS Coding Scheme

E-UTRAN Evolved UMTS Radio Access Network

GERAN GSM/EDGE Radio Access Network

LTE Long Term Evolution

MTC Machine Type Communication

PBCCH Packet Broadcast Control CHannel

PCH Paging CHannel

PTCCH Packet Timing Control CHannnel

RACH Random Access CHannel

RLC/MAC Radio Link Control/Medium Access Control

TFI Temporary Frame Identity

USF Uplink State Flag

UTRAN UMTS Radio Access Network

### LIST OF REFERENCES

1, 3 methods for transmitting data

11 receiving and transmitting

12, 13 signalling

2 radio base station

21 transmitting means

22, 23 signalling means

31 receiving

32 listening

33 transmitting

34, 35 receiving

4 radio device

41 receiving means

42 listening means

43 transmitting means

44, 45 receiving means

5 channel

51 radio block

51, 53 second subset of the sequence of radio blocks

52, 54 first subset of the sequence radio blocks

51, 52, sequence of radio blocks

53, 54

511 resource allocation map

5111 update period indicator

512 user traffic

513 common control channel information

5131 broadcast information

5132 access grant information

5133 paging information

514 uplink state flag

62, 64 first group of radio devices

61, 63 second group of radio devices

7 broadcast channel

71 indication

1. Method for a radio base station, the method comprising receiving and transmitting, on a channel, a sequence of radio blocks, the sequence further being divided into a first subset of the sequence of radio blocks which is allocated for user traffic of a first group of radio devices or of a second group of radio devices, and into a second subset of the sequence of radio blocks which is allocated for common control channel information relating only to the second group of radio devices, wherein the first and second subsets of radio blocks are transmitted on the same channel.

2. Method according to claim 1, wherein a radio block of the second subset of the sequence of radio blocks comprises an uplink state flag related to a radio device of a first group of radio devices or to a second group of radio devices, and wherein the radio block further comprises common control channel information relating to a radio device of the second group of radio devices.

3. Method according to claim 1, the method further comprising signalling, on the channel, a resource allocation map, the resource allocation map specifying the sequence of radio blocks allocated for transmissions over the channel.

4. Method according to claim 3, wherein the resource allocation map further comprises an update period indicator, the update period indicator defining a time interval during which the resource allocation map is valid.

5. Method according to claim 1, wherein the common control channel information comprises broadcast information or access grant information or paging information related only to the second group of radio devices.

6. Method according to claim 1, the method further comprising signalling, on a broadcast channel, an indication on the presence of the channel and resource allocation information on the channel.

7. Radio base station comprising receiving and transmitting means configured for receiving and transmitting, on a channel, a sequence of radio blocks, the sequence further being divided into a first subset of the sequence of radio blocks which is allocated for user traffic of a first group of radio devices or of a second group of radio devices, and into a second subset of the sequence of radio blocks which is allocated for common control channel information relating only to the second group of radio devices, wherein the first and second subsets of radio blocks are transmitted on the same channel.

8. Radio base station according to claim 6, wherein a radio block of the second subset of the sequence of radio blocks comprises an uplink state flag related to a radio device of a first group of radio devices or to a second group of radio devices, and wherein the radio block further comprises common control channel information relating to a radio device of the second group of radio devices.

9. Radio base station according to claim 7, the radio base station comprising resource allocation map signalling means configured for signalling, on the channel, a resource allocation map, the resource allocation map specifying the sequence of radio blocks allocated for transmissions over the channel.

10. Radio base station according to claim 9, wherein the resource allocation map further comprises an update period indicator, the update period indicator defining a time interval during which the resource allocation map is valid.

11. Radio base station according to claim 7, wherein the common control channel information comprises broadcast information or access grant information or paging information related only to the second group of radio devices.

12. Radio base station according to claim 7, said radio base station further comprising signalling means configured for signalling, on a broadcast channel, an indication on the presence of the channel and resource allocation information on the channel.

13. Method for a radio device, the method comprising receiving and transmitting, on a channel, a sequence of radio blocks the sequence further being divided into a first subset of the sequence of radio blocks which is allocated for user traffic of a first group of radio devices or of a second group of radio devices, and into a second subset of the sequence of radio blocks which is allocated for common control channel information relating only to the second group of radio devices, wherein the first and second subsets of radio blocks are transmitted on the same channel.

14. Method according to claim 13, wherein a radio block of the second subset of the sequence of radio blocks comprises an uplink state flag related to a radio device of a first group of radio devices or to a second group of radio devices, and wherein the radio block further comprises common control channel information relating to a radio device of the second group of radio devices.

15. Method according to claim 13, the method further comprising receiving, on the channel, a resource allocation map, the resource allocation map specifying the sequence of radio blocks allocated for transmissions over the channel.

16. Method according to claim 15, wherein the resource allocation map further comprises an update period indicator, the update period indicator defining a time interval during which the resource allocation map is valid.

17. Method according to claim 13, wherein the common control channel information comprises broadcast information or access grant information or paging information related only to the second group of radio devices.

18. Method according to claim 13, the method further comprising receiving, on a broadcast channel, an indication on the presence of the channel and resource allocation information on the channel.

19. Method according to claim 13, the method further comprising:
listening to common control channel information only within a radio block of the subset of the sequence of radio blocks; and/or
transmitting common control channel information only within a radio block of the subset of the sequence of radio blocks.

20. Radio device comprising receiving and transmitting means configured for receiving and transmitting, on a channel, a sequence of radio blocks, the sequence further being divided into a first subset of the sequence of radio blocks which is allocated for user traffic of a first group of radio devices or of a second group of radio devices and into a second subset of the sequence of radio blocks which is allocated for common control channel information relating only to the second group of radio devices, wherein the first and second subsets of radio blocks are transmitted on the same channel.

21. Radio device according to claim 20, wherein a radio block of the second subset of the sequence of radio blocks comprises an uplink state flag related to a radio device of a first group of radio devices or to a second group of radio devices, and wherein the radio block further comprises common control channel information relating to a radio device of the second group of radio devices.

22. Radio device according to claim 19, the radio device further comprising receiving means configured for receiving, on the channel, a resource allocation map, the resource allocation map specifying the sequence of radio blocks allocated for transmissions over the channel.

23. Radio device according to claim 22, wherein the resource allocation map further comprises an update period indicator, the update period indicator defining a time interval during which the resource allocation map is valid.

24. Radio device according to claim 20, wherein the common control channel information comprises broadcast information or access grant information or paging information related only to the second group of radio devices.

25. Radio device according to claim 20, the radio device further comprising receiving means configured for receiving, on a broadcast channel, an indication on the presence of the channel and resource allocation information on the channel.

26. Radio device according to claim 20, the radio device further comprising:
listening means configured for listening to common control channel information only within a radio block of the second subset of the sequence of radio blocks; and
transmitting means configured for transmitting common control channel information only within a radio block of the subset of the sequence of radio blocks.
